(19) United States
(12) Patent Application Publication
(10) Pub. No.: US 2008/0240270 A1
(43) Pub. Date: Oct. 2, 2008

(54) INTERFERENCE DETECTION AND AVOIDANCE SIGNALLING AND PROCESSING

(75) Inventors: Justin Coon, Bristol (GB); Steve Carl Jamieson Parker, Bristol (GB)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/954,930

(22) Filed: Dec. 12, 2007

(30) Foreign Application Priority Data
Feb. 21, 2007 (GB) 0703392.1

(51) Int. Cl. H04L 27/28; H04B 1/00; H04B 1/10

(52) U.S. Cl. 375/260; 455/63.1; 375/346; 375/296

(57) ABSTRACT

The present invention relates to a method of generating a signal for transmission over a channel subject to transmission conditions. A corresponding signal and a method of receiving a signal over a channel subject to transmission conditions are also disclosed. The invention further relates to a transmitter and a receiver.

The present invention relates to wireless communications systems that are affected by transmission conditions in the channel. More particularly, it relates to wireless communications systems that must coexist in the presence of narrowband interference from other radio systems.

Constraints imposed by transmission conditions in the channel apply to ultra-wide band (UWB) transmission in particular, because spectral regulators in the EU and Japan have insisted that interference Detection And Avoidance (DAA) must be applied in certain bands of the UWB allocated spectrum (defined by the FCC in the US to extend from 3.1 GHz to 10.6 GHz, with maximum power spectral densities of −41.3 dBm/MHz). Accordingly, interference has become an important transmission condition in the channel. The FCC UWB spectrum has been partitioned into fourteen 528 MHz bands by a PHY layer proposal to IEEE 802.15.3a that has since been backed by the powerful WiMedia Alliance and standardised by ECMA (ECMA-368 standard, 1 Dec. 2005, http://www.ecma-international.org/publications/standards/Ecma-368.htm). Five ‘Band Groups’ have also been defined, with the first four Band Groups containing three bands each and the fifth Band Group containing the two highest frequency bands.

In the ECMA-368 standard referred to above, support of multiple wireless personal area networks (WPANs) is provided by two mechanisms: operation in different Band Groups; and isolation of WPANs within a common Band Group using different time frequency codes (TFCs) for each unique WPAN. The TFCs work by dividing each packet into blocks of six OFDM symbols. Each of the OFDM symbols within each block of six is transmitted from a pre-assigned band from within the chosen Band Group. The bands used for each consecutive OFDM symbol are defined by the TFCs.

TFCs improve the performance of systems based on the ECMA-368 standard by interleaving information bits throughout the blocks of six OFDM symbols to maximise frequency diversity. The TFCs that provide this frequency diversity are known as time-frequency interleaved (TFI) logical channels. However, in certain circumstances it may be preferable to operate each WPAN in always the same band and therefore fixed TFCs are also provided—these are termed fixed frequency interleaved (FFI) logical channels. FFI logical channels must be used if not all of the bands in a Band Group are available due to regulatory restrictions.

First generation UWB devices are likely to operate only in the first Band Group and therefore for these devices it is only necessary to perform interference DAA in this 1.5 GHz band. However, future devices may migrate throughout the whole 7.5 GHz of available bandwidth (see below for regional regulatory restrictions). A general DAA solution will therefore have to be capable of detecting interference and performing avoidance and suppression over 7.5 GHz.

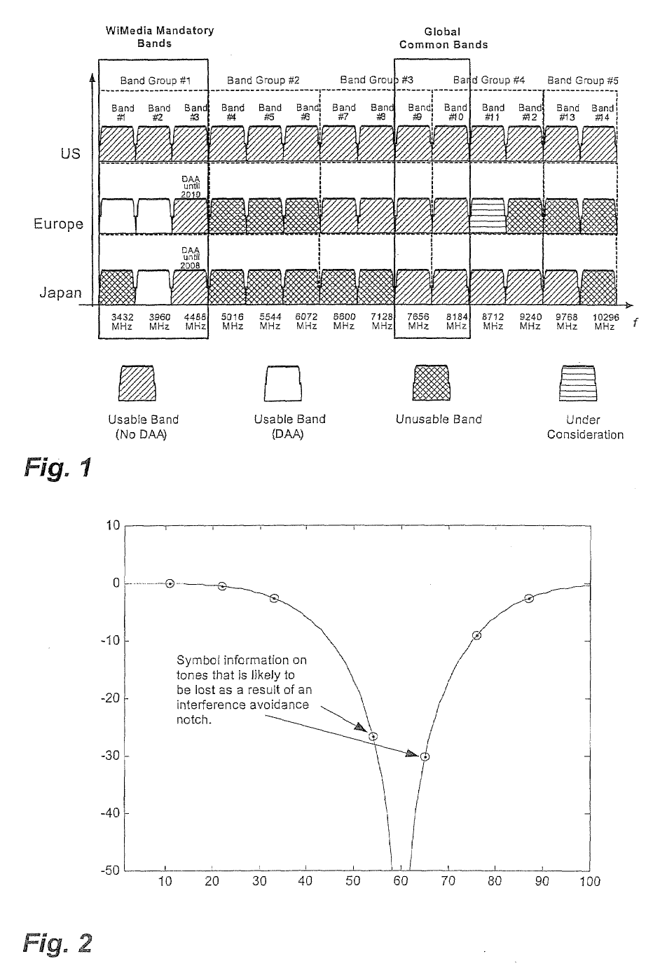

FIG. 1 shows how the UWB band is partitioned into band groups and regulated in the US, EU and Japan. It is apparent that in the economically attractive Band Group #1, two out of the three bands can only be used in the EU if DAA is applied. The remaining third band can only be used without DAA present until 2010, after which the whole band group requires DAA technology. In Japan, the regulatory stance is even firmer and only two bands of the Band Group of three bands can be used, with one band requiring DAA and the other requiring DAA after 2008. DAA is therefore a critical technology for the future evolution of UWB civilian communications in the EU and Japan. In the US, DAA is not required, but they may adopt DAA technology in the future if it is shown to be effective and can be applied cheaply and efficiently.

The relatively coarse division of the UWB FCC spectrum into fourteen 528 MHz bands means that it would not take many narrowband interferers, distributed evenly throughout the UWB spectrum, to render UWB devices unusable if techniques are not used to aid co-existence in the same bands.

Several problems arise when implementing interference DAA. References are made to UWB, but the invention is generally applicable. If DAA is used with an OFDM transmitter then frequency notching of the transmitted waveform, to avoid causing interference to third parties, will destroy any symbols encoded on these tones.

FIG. 2 illustrates a situation where some information bearing tones, indicated by circles, are attenuated by the applied interference avoidance notch and may be unrecoverable if the forward error correction code is not sufficiently powerful. This may prevent operation at high data rates, or when the signal-to-noise ratio (SNR) is low. If a frequency notch punctures data tones, then e.g. a video streaming application may not work acceptably.

Another problem with interference avoidance is that a device may not have detected interference, even though third party devices are present, which could be disrupted by the device's future transmissions. There are numerous reasons why interference may not have been detected:
A device was not listening on the correct frequency when an interference event occurred (a 7.5 GHz band may need to be monitored).
A device's interference detection circuit was inactive when the event occurred (e.g. it was in sleep mode to conserve power, or the device was busy transmitting or receiving).
A device is too simple and inexpensive to have an interference detection capability.
A device is running low on batteries and cannot afford to operate interference detection.

It is useful if a network shares the burden of interference detection, particularly as some devices may be more equipped for the task than others. For example, larger non-portable devices such as PCs could support more regular background interference monitoring, because of their superior processing ability and virtually unlimited power.

A potential problem of applying interference DAA to the OFDM-based ECMA-368 standard is that channel estimation training sequences are designed to be decoded in the frequency domain. If these sequences are transmitted without modification then they will cause interference to in-band third party devices. If active interference cancellation (AIC) frequency notching (H. Yamaguchi, “Active interference cancellation technique for MB-OFDM cognitive radio,” in Proc. of the 34^{th} Microwave Conference, Vol. 2, October 2004, pp. 1105-1108, incorporated herein by reference) is applied then two problems arise: the notched spectrum will be misinterpreted as a fade; and the AIC tones would be different to the expected symbols on the respective tones and therefore erroneous channel estimates would be obtained on those frequencies. Consequently, the characteristics of the frequency notch should be known prior to channel estimation in such systems.

Accordingly, aspects of the present invention seek to mitigate, alleviate or eliminate at least some of the above mentioned problems or disadvantages.

According to a first aspect of the present invention, there is provided a method of generating a signal for transmission over a channel subject to transmission conditions. The method comprising the steps of receiving information relating to a transmission condition in said channel, providing, within said signal, a structure for transmission conditions signalling, encoding said information in said signalling structure, and transmitting said signal adapted to the transmission conditions.

In a configuration of the above aspect said signalling structure is used to convey information relating to said transmission condition and channel estimation.

In another configuration of the above aspect said transmission condition comprises interference detection and avoidance.

In a further configuration of the above aspect said step of encoding comprises selecting said signalling structure from a set of predetermined sequences, wherein each sequence corresponds to a particular transmission condition.

In a configuration of the above aspect said signalling structure comprises a sequence of said predetermined sequences corresponding to a plurality of transmission conditions.

In another configuration of the above aspect the predetermined sequences are adapted to their corresponding transmission conditions.

In a further configuration of the above aspect the predetermined sequences are substantially mutually uncorrelated.

In a configuration of the above aspect the number of predetermined sequences in the set is equal to or greater than the number of possible transmission conditions to be conveyed.

According to a second aspect of the present invention, there is provided a signal for transmission over a channel subject to transmission conditions. The signal comprises a packet structure; a signalling structure provided within the packet structure for conveying information relating to said transmission condition. The signal is further adapted in accordance with said transmission condition.

In a first configuration of the second aspect said signalling structure comprises an extended signalling structure.

In a further configuration of the second aspect said signalling structure is provided in the beacon period of a MAC superframe.

In another configuration of the second aspect said signalling structure is provided in the preamble of the PHY frame structure.

In a configuration of the second aspect the signalling structure is provided after the synchronisation field and before the channel estimation field.

In a further configuration of the second aspect wherein the signalling structure is collocated with the channel estimation field.

According to a third aspect of the present invention, there is provided a method of receiving a signal over a channel subject to transmission conditions. The signal comprises a signalling structure relating to the transmission condition. The method comprises the steps of receiving said signal, autocorrelating said signal, and decoding said signalling structure. The reception of further signals is adapted to the transmission condition conveyed in the signalling structure.

In a configuration of the third aspect coarse synchronisation is performed before decoding the signalling structure relating to the transmission condition

In another configuration of the third aspect the step of decoding said signalling structure comprises performing a predetermined number of correlations corresponding to the number of predetermined sequences. Each correlation result is windowed in accordance with the synchronisation information. The value of each windowed result is squared and integrated. The sequence obtaining the highest value is determined. The transmission condition related to the determined sequence is identified.

In a further configuration of the third aspect the step of windowing further comprises matching the centre of each window is to the zero-lag point in the output waveform of the correlation.

In yet another configuration of the third aspect the transmission condition comprises interference detection and avoidance.

According to a fourth aspect of the present invention, there is provided a transmitter adapted to generate a signal for transmission over a channel subject to transmission conditions in accordance with the first aspect or any of its configurations.

According to a fifth aspect of the present invention, there is provided a receiver adapted to receive a signal over a channel subject to transmission conditions in accordance with the third aspect or any of its configurations.

These and other aspects of the invention will now be further described, by way of example only, with reference to the accompanying figures.

FIG. 1 illustrates the international assignment of bands for UWB.

FIG. 2 illustrates the loss of information carried on tones due to a DAA notch.

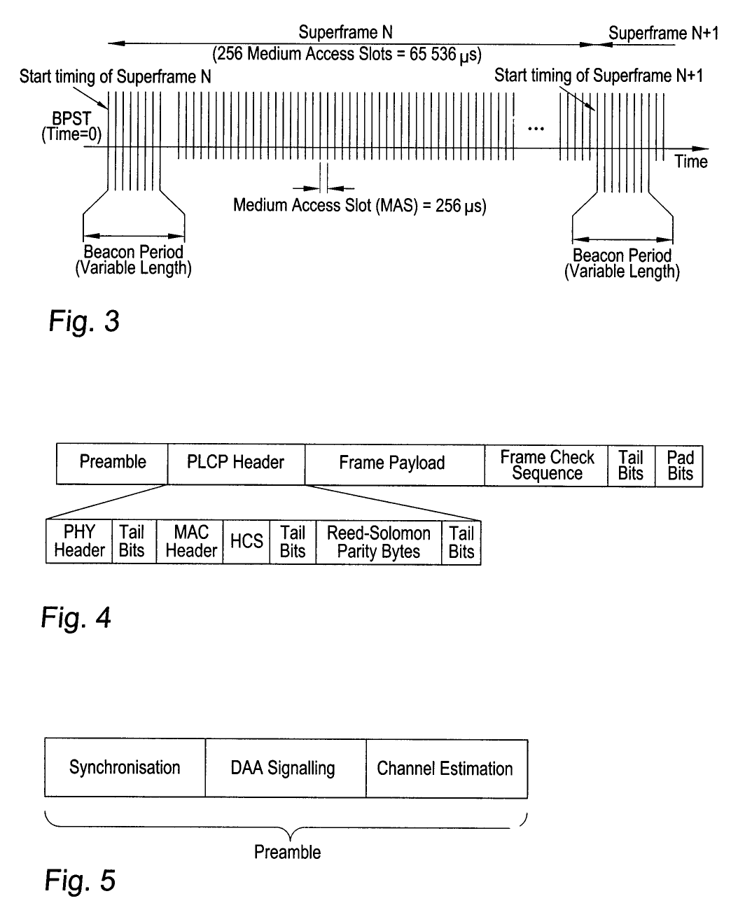

FIG. 3 shows the position of the beacon period at the beginning of a MAC superframe used by ECMA-368.

FIG. 4 depicts the PHY frame structure used by ECMA-368.

FIG. 5 shows the preamble with separate DAA signalling and channel estimation fields.

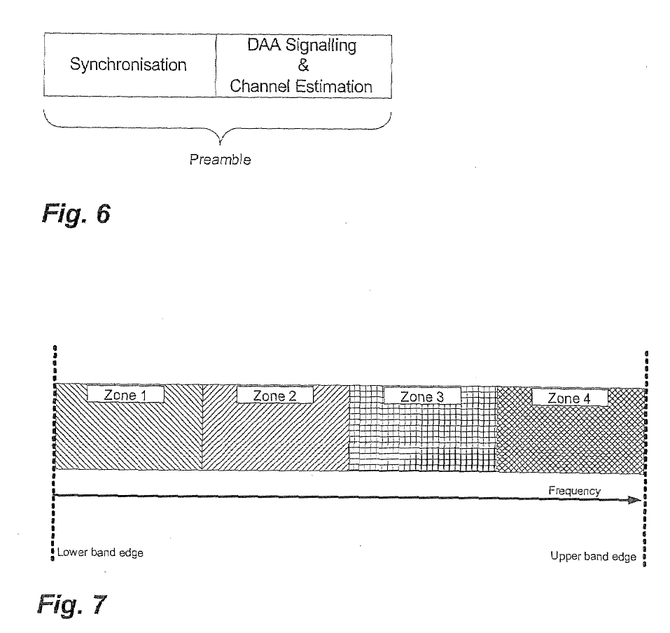

FIG. 6 illustrates the preamble with combined DAA signalling and channel estimation field.

FIG. 7 illustrates of the zones used for coarse frequency estimation of the interferer.

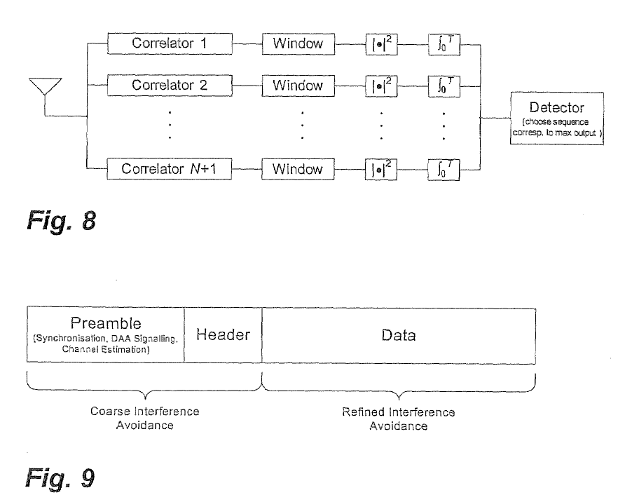

FIG. 8 shows a receiver architecture for detection of interference avoidance information.

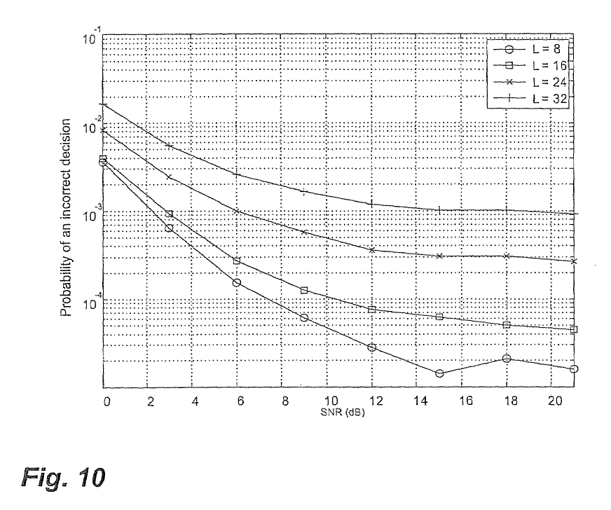

FIG. 9 Illustrates the use of coarse and refined interference avoidance templates (based on signalling refinement in the header of the packet).

FIG. 10 depicts the probability of incorrectly identifying the interference avoidance template as a function of SNR for different channel lengths when the proposed invention is used.

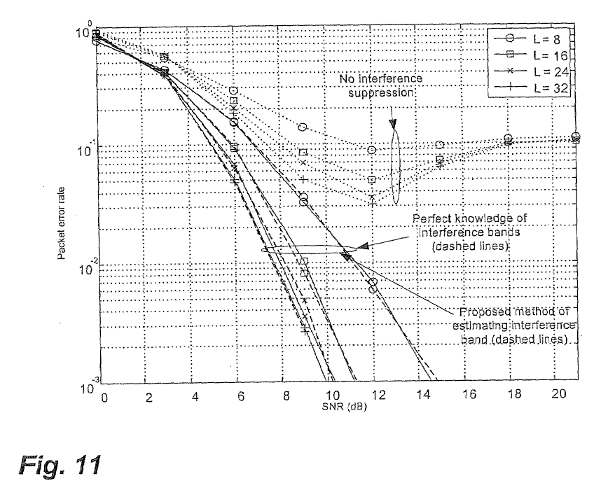

FIG. 11 shows a diagram illustrating the probability of packet error vs. SNR for a system that uses the proposed invention.

The present invention provides for sharing intelligence about transmission conditions, particularly interference. Several advantages may be achieved: duplicated effort may be minimised; the workload on devices that have limited resources (power or processing) may be reduced; hidden nodes may be avoided; rapid training over ultra-wide bandwidths may be enabled; and diversity of information to maximise reliability may be provided.

The present invention provides a method for signalling that transmission conditions in the channel have been detected, so that a receiver is aware that the transmitted signal has been adapted. In particular, the invention provides a method for signalling that interference detection and avoidance (DAA) techniques are in use, so that a receiver is aware that the transmitted signal has been frequency notched. Furthermore, a mechanism is provided that allows the centre frequency and bandwidth of the interferer to be determined by the receiver, without the transmitter using any of the frequencies occupied by the interferer when signalling to avoid causing interference to third parties. With this information a receiver may then decode transmitted information with maximum reliability and can configure front-end filters to maximise dynamic range.

The basic assumption for this invention is that a device has already detected and characterised a transmission condition, such as a third party interferer. This detection is discussed elsewhere. The central idea behind this invention is that a signalling structure is used to signal the presence of a transmission condition in the channel. Advantageously interference and the application of interference DAA is being signalled. Thus, a network of devices will remain up-to-date with information about transmission conditions, such as interference from third party devices, and will be able to adapt to the transmission conditions, e.g. to avoid interfering with these parties as well as suppress these parties' transmissions to facilitate detection and decoding.

A potential solution to the signalling problem is to use an extended signalling field at the beginning of a packet transmission to convey extra information. In practice, this signalling structure could be multi-purpose to eliminate, or minimise, additional overheads. For example, if a UWB system is being considered then the beacon period of the MAC superframe (FIG. 3) could be used, so that a device learns about interference as soon as it joins the network. Alternatively, the preamble at the start of the PHY frame structure (FIG. 4) could be used to jointly achieve conveyance of interference information and channel estimation. Other communication systems will have similar fields that can be exploited in this fashion.

The structure of a packet, regardless of the specific system, will typically resemble that depicted in FIG. 4. The signalling field in this invention can be located anywhere in the packet, but it is most useful to place the field in the preamble so that the necessary information about the interference avoidance scheme that will be used in the remainder of the packet (and possibly subsequent packets) can be conveyed to the receiving device(s) at the beginning of a transmission. In an embodiment of this invention, this signalling field is placed after the synchronisation field and before the channel estimation field (see FIG. 5). In another embodiment, the signalling and the channel estimation fields are collocated in the packet (see FIG. 6), which leads to joint signalling of interference avoidance information and channel estimation, thus reducing the overhead caused by the additional signalling field.

It is important to note that in this invention, coarse synchronisation must take place before the interference avoidance signalling scheme can be decoded properly. This requirement is similar to the approach that is used in IEEE 802.11a devices where channel estimation is performed after coarse synchronisation. It should be noted, however, that the synchronisation signal in this invention undergoes a spectral nulling process so that interference is not caused to third party devices. Therefore, synchronisation should most likely be performed at the receiver by correlating the received signal with itself (autocorrelation) rather than with a known sequence that may be stored in the receiver (crosscorrelation).

The transmitter chooses to transmit one or more sequences from a set of sequences in the DAA signalling field. These sequences are predetermined and the whole set is known at both the transmitter and the receiver. Each sequence in the set corresponds to a particular interference condition. For example, if the transmitter has detected that no interfering transmissions are present in the medium, it will transmit a particular sequence (out of the set of sequences) corresponding to this state. If, on the other hand, the transmitter has detected that interference is present, it will transmit a different sequence to convey that this is the case. For each predetermined interference state, there will exist a sequence corresponding to the state. Alternatively, multiple sequences can be transmitted sequentially within the DAA signalling field to convey more complex interference scenarios, such as when third party devices are transmitting on several parts of the band.

It should be noted that when a signalling sequence is transmitted, it must also adhere to the current interference avoidance template. For example, if the transmitter determines that a third party device is operating in band b, it transmits the unique sequence out of the set that conveys to the receiver that interference avoidance will be implemented in band b (this is the interference avoidance template). Furthermore, this signalling sequence is designed such that it has a notch of a predetermined depth in band b. Thus, the sequence not only conveys to the receiver the exact interference avoidance template that will be used in subsequent transmissions, it adheres to this template, itself, so that its transmission will not interfere with third party devices.

The sequences in the set should also be designed to be as mutually uncorrelated as possible so that they will have a unique signature and, thus, may be easily distinguished from each other at the receiver.

The number of sequences in the set shall be such that all interference avoidance scenarios can be conveyed. For example, assume the transmitter partitions the band into N possibly overlapping subbands, and the transmitter has the ability to null each of these subbands individually, thus transmitting using the remaining bandwidth. Consequently, there are N+1 possible interference avoidance scenarios: one of N possible notches and the condition where the signal is not notched because no interferer has been detected. Thus, at any given signalling interval, the transmitter must choose to transmit one of the N+1 sequences—in particular, the sequence that corresponds to the interference avoidance template that is applied to the subsequent signal (or the sequence that corresponds to no notch being applied if this is the case). FIG. 7 illustrates how a band may be divided into zones for coarse frequency estimation of an interferer. The signalling sequence used by the transmitter is dependent on which zone the interferer is located in.

Sequences with good periodic correlation properties were discovered by Chu (D.C. Chu, “Polyphase codes with good periodic correlation properties,” IEEE Trans. Info. Theory, July 1972, pp 531-532, incorporated herein by reference). The p^{th} element of a length-K Chu sequence is defined as

$${a}_{p} = \{ \begin{matrix}{e}^{j π {rp}^{2} / K} , even K \\ {e}^{j π rp ( p + 1 ) / K} , odd K\end{matrix}$$

where r and K are relatively prime. Chu sequences have the nice property that the periodic correlation of any sequence with itself is zero at any nonzero lag. It is this property that facilitates the use of these sequences as a base for the construction of DAA signalling sequences.

Chu sequences can be used to form a set of signalling sequences in the following manner. Assume there are N predetermined interference avoidance (i.e. notching) bands. Choose M unique Chu sequences of a given length K (K is typically the number of symbols in a block or the number of subcarriers in an OFDM system). These M sequences must be used to construct N+1 DAA signalling sequences, one for each notching band and one additional sequence to signal the ‘no interference avoidance’ state. Each original Chu sequence is used to create a number of additional sequences by cyclically shifting the original sequence by a number of places. It is beneficial to maximise this shift within the period K so that the orthogonality between two sequences is maintained even after they are transmitted through a dispersive channel (this results from the fact that correlation and convolution are linear and associative operations). Thus, the burden of sequence mutation should be shared equally amongst all original sequences, in which case

$$⌈ \frac{N + 1}{M} ⌉ - 1$$

shifted sequences should be derived from each original sequence in order to ensure all N+1 interference avoidance scenarios are supported (539 •┐ denotes the argument rounded to the next highest integer). In this case, each original sequence should be shifted by multiples of

$$⌊ \frac{K}{⌈ ( N + 1 ) / M ⌉} ⌋$$

symbols to obtain the total set of signalling sequences (└•┘ denotes the integer part of the argument).

By using this conservative approach, there will be some redundant or leftover sequences, but these can be discarded, or alternatively, the restrictions given above can be relaxed for some sequences. The latter approach would result in some sequences having slightly better correlation properties than other sequences, but the overall goal would still be achieved.

Each of the resulting N+1 sequences are considered to be defined in the frequency domain. In the case of Chu sequences, this does not pose a problem since the discrete Fourier transform (DFT) of a Chu sequence is another sequence with good correlation properties. For each sequence, the appropriate symbols (corresponding to the subcarriers/tones that should be notched for that sequence) are set to zero. Each resulting sequence is then processed with an inverse DFT (IDFT) to obtain a sequence defined in the time domain (the power of the sequence is normalised after transformation). In order to ensure that a given sequence has a spectral null in the appropriate place, an interference avoidance algorithm can be applied to each time-domain sequence. One such algorithm that can be used involves computing a time-domain window that is applied to the transmitted signal. This window is a function of the unwindowed signal, and can be computed using standard convex (nonlinear) optimisation techniques where the objective is to find the window that, when applied to the transmitted signal, creates a spectral notch of a predetermined depth in a specific part of the frequency band. It should be noted that this nulling process alters the correlation properties of the sequences, but as long as the null has a relatively small width (i.e. on the order of K/10) this alteration will not be enough to significantly affect performance. The construction of signalling sequences from Chu sequences is summarised below.

1. Choose M Chu sequences, each of length K. The sequences will be distinguished by the unique parameters r₁, r₂, . . . , r_{M}. Preferably, K and |rₘ−rₙ| are relatively prime for all m≠n, although this is not a requirement.
2. For the m^{th} original Chu sequence, ┌(N+1)/M┘−1 additional sequences are derived, where the ith sequence is simply the original sequence cyclically shifted by i×└K/┌(N+1)/M┐┘ for i=1, 2, . . . , ┌(N+1)└−1.
3. N+1 sequences are retained out of the M×r┌(N+1)/M┐ that were generated.
4. For the nth sequence (frequency domain), the symbols corresponding to the nth interference avoidance template are equated to zero. One sequence is left unaltered (this corresponds to the ‘no interference’ state).
5. Each sequence is transformed to the time domain with an IDFT of length K. The resulting sequences are normalised appropriately.
6. A suitable residual interference suppression algorithm is applied to the N time domain sequences corresponding to interference events. (Alternatively, a technique such as AIC can be applied in the frequency domain prior to step 5, but this will lead to poorer performance).

Instead of Chu sequences, Frank sequences or similar sequences may also be used.

The receiver is assumed to be unaware of the current interference (avoidance) state prior to reception of the signalling sequence(s) in this invention. Thus, following the preamble structure illustrated in FIGS. 5 and 6, the receiver first receives the synchronisation signal, autocorrelates this signal, and performs coarse synchronisation. Then the signalling field of the preamble is received. This signal is passed through a bank of correlators (see FIG. 8) where each correlator is matched to one of the N+1 possible transmitted signals. The output of each correlator is windowed according to the synchronisation information so that unwanted correlation sidelobes are suppressed. The absolute value of each windowed signal is then squared and integrated to obtain a decision metric. The integration is performed over the window to collect the energy of the crosscorrelation of the sequences, which has been dispersed in time due to the multipath channel. The metric with the highest value is assumed to correspond to the actual transmitted signal, and the receiver estimates that the sequence used in the corresponding correlator was the transmitted sequence. Thus, the current interference avoidance template has been estimated without knowledge of the channel or transmitted signal. With this knowledge of the (coarse) interference avoidance template, the receiver can apply any number of appropriate interference suppression algorithms to facilitate detection of the subsequent data message.

Different mathematical definitions exist for correlation. It will be understood that in some systems, the correlators in the receiver may be designed according to the periodic correlation definition, whereas in other systems, aperiodic correlation may be used.

The design of the window that is used is related to the design of the correlators. Typically, the centre of the window will be designed to be matched to the zero-lag point in the output waveform of the correlators. The width of the window should take into account the (approximate) dispersion in the channel, the error in coarse synchronisation, and the minimum cyclic shift of each signalling sequence (in the case where Chu sequences are used). For example, if the channel dispersion is on the order of L=5 symbols, the synchronisation tolerance is ±4 symbols, and the minimum cyclic shift of each (Chu) signalling sequence is 16 symbols, the window should be designed to be on the order of no more than ±8 symbols since beyond this point, correlation sidelobes may be high due to the cyclic shift of the next nearest sequence.

The signalling method proposed above can be restrictive in the sense that the number of possible interference scenarios is limited by the number of sequences (and correlators) that can be supported. In some cases, it may be beneficial to use a coarse interference avoidance template to perform initial channel estimation and detection of the header of a packet, and later refine the interference avoidance template in order to

1. reduce the complexity associated with implementing interference avoidance at the transmitter (typically, the complexity of the notching algorithm scales with the width of the required notch);
2. improve the probability that a packet is received correctly;
3. increase the throughput of a transmission (e.g. to achieve a given packet error rate, a system might employ a low-order modulation scheme such as BSPK if the notch is wide, or a higher-order scheme such as 16-QAM if the notch is narrow; this results from the additional information that can be signalled for a narrow notch).

To achieve this goal, additional signalling must be performed so that the transmitter and the receiver are able to communicate effectively. This signalling can be embedded in the header, which is transmitted and detected using the coarse interference avoidance template. Once the refinement is decoded from the header, it can be applied in the data payload of the packet, as shown in FIG. 9.

If more explicit information is required during the DAA signalling phase—for example, that two third party devices are transmitting on different bands—this information can be conveyed by using multiple sequences and multiple interference avoidance templates can be applied dynamically to the set of N+1 original sequences. An example of this scenario is as follows. Suppose third party devices are deemed to be transmitting in bands b and c. The transmitter can use two signalling slots to transmit the sequences corresponding to templates b and c. However, sequence b is typically designed with a spectral null in band b, and sequence c is typically designed with a spectral null in band c. The transmitter must, in this case, apply a signal notching algorithm to sequences b and c. This additional notching will degrade the correlation properties of the two sequences slightly, but the typical receiver correlation process described above can still be used to estimate that templates b and c have been and will be used for subsequent transmissions.

The present invention achieves two main functions: it signals important information about an interferer (frequency and bandwidth) in a coarse manner; and it signals that frequency notching has been applied for the transmitted signals. This has many associated advantages that are discussed below.

A desirable requirement of the signalling sequences is that they are implemented in the time domain, so that they do not, in general, require the use of a DFT once they have been constructed. This increases generality and reduces processing latency and complexity.

Also, the skilled person will recognise that multiple correlators may not be necessary to process the received signalling sequences. For example, if shifted Chu sequences are used as signalling sequences, a single correlator may be used for each subgroup of sequences (i.e. all sequences are derived from a single sequence) where an appropriate cyclic lag can be used to ‘synchronise’ the correlator with the received signal.

For additional signalling more than N+1 sequences can be constructed for use during the DAA signalling phase so that more information can be conveyed about the interference and/or interference avoidance template(s). For example, one sequence might be mapped to the event that there is too much interference in the band, and all devices in a network must hop to a different band (the identity of the band to hop too could also be signalled in the DAA signalling field). Alternatively, a transmitter could convey to a set of receivers that they should not transmit at all due to the level of interference. The skilled engineer will recognise that there are many different scenarios where additional information could be conveyed to a receiver using similar signalling sequences.

One particular scenario that would benefit from additional signalling is the case where more than one signalling sequence must be used to convey the interference avoidance template (see the section on Complicated Interference Avoidance Templates above). In this case, the signalling field may be
of a fixed length (e.g. three symbols) that is known to both the transmitter and the receiver(s), or
of a variable length, which can be lengthened to facilitate the accurate signalling of a complicated interference avoidance template, or shortened when the template is simple (e.g. in the case of one third party interferer).

In the latter of these scenarios, the receiver must be able to determine when the DAA signalling field ends. This can be accomplished by reserving one signalling sequence at the transmitter (and a corresponding correlator at the receiver) as an ‘end of field’ sequence. This sequence must be dynamically notched at the transmitter to adhere to the overall interference avoidance template. By transmitting this sequence at the end of the DAA signalling field and processing the received sequence with the bank of correlators, the receiver will (in general) be able to determine when the DAA signalling field ends.

A desirable feature is that the sequences can be interpreted prior to channel estimation. This inevitably increases the difficulty of designing the sequences, because the correlation at the receiver is not a perfect autocorrelation but a weaker crosscorrelation with a temporally dispersed sequence (due to the distortion caused by the transmission of the sequence through a multipath channel—see discussion above). If the Chu sequence approach is used to design the signalling sequences, channel estimation follows easily without the aid of an additional channel estimation field (FIG. 6) once the transmitted signalling sequence is determined using the correlator bank described above. This is due to the fact that Chu sequences are, in general, optimal for channel estimation in block transmission systems such as OFDM and cyclic-prefixed single-carrier systems. Although the spectral nulling of the Chu sequences leads to a slight suboptimality, this does not lead to a large degradation in the accuracy of the channel estimate. Furthermore, the channel may be updated during the reception of the header and data by using pilot symbols that are typically inserted into these fields in a packet.

It is interesting to study the performance of the proposed algorithm in terms of the probability that the interference avoidance template is incorrectly identified. FIG. 10 depicts a diagram showing the probability of incorrectly identifying the interference avoidance template as a function of SNR for different channel lengths L when the proposed invention is used. The diagram shows this metric as a function of SNR for several channels with varying degrees of dispersion (indicated by L in the diagram). The power of the interferer in this example is 10 dB (relative to the desired signal power). The figure shows that the performance of the proposed invention is dependent upon the channel dispersion, but generally performs well (<10⁻² probability of error) when the Chu sequence approach is used to construct signalling sequences.

Following these results, the diagram in FIG. 11 shows the packet error rates of systems that use various methods of estimating the interference band. From the figure, it is obvious that the systems that do not estimate the interference band or suppress interference perform poorly. However, it is also shown that the proposed technique allows systems to estimate the interference band and suppress interference in an (almost) ideal manner. Indeed, the performance of a system that uses the proposed technique is no different than that of a system that has perfect knowledge of the interference template at the receiver.

At present, there is no established method for performing interference DAA; and this invention could be applied to radio systems such as ultra wideband (UWB) and, more generally, cognitive radio, where flexible and responsible operation within an extensive bandwidth is desired.

The present invention may also be useful when a component of the time domain signal sampled by the analogue-to-digital converter (ADC) is interference. This may arise if a receiver has not detected the interference and therefore has not applied any counter-measures; or if the applied counter-measures are incapable of fully suppressing the interference because it is too strong. Any remaining interference sampled by the ADC will be spread across all of the time domain samples. If a single carrier system is considered then this interference will corrupt all of the time domain constellation symbols, resulting in an irreducible bit error rate floor. This invention counters this problem and increases both the SNR and signal-to-interference noise ratio (SINR).

The present invention addresses co-existence in the same bands and maximises the amount of spectrum available to UWB devices while not causing interference and managing the interference imposed upon them.

A receiver in accordance with the present invention may robustly determine at least the frequency and bandwidth of the interference avoidance notch.

One of the potential applications for the present invention is for UWB when streaming video in the presence of interference. Video streaming demands both a high data rate and a very low packet error rate. By using appropriate signalling, this type of application may work acceptably.

No doubt many other effective alternatives will occur to the skilled person. It will be understood that the invention is not limited to the described embodiments and encompasses modifications apparent to those skilled in the art lying within the spirit and scope of the claims appended hereto.

1. A method of generating a signal for transmission over a channel subject to transmission conditions, the method comprising the steps of:
receiving information relating to a transmission condition in said channel;
providing, within said signal, a structure for transmission conditions signalling;
encoding said information in said signalling structure; and
transmitting said signal adapted to the transmission conditions.

2. The method according to claim 1, wherein said signalling structure is used to convey information relating to said transmission condition and channel estimation.

3. The method according to claim 1, wherein said transmission condition comprises interference detection and avoidance.

4. The method according to claim 1, wherein said step of encoding comprises selecting said signalling structure from a set of predetermined sequences, wherein each sequence corresponds to a particular transmission condition.

5. The signal according to claim 4, wherein said signalling structure comprises a sequence of said predetermined sequences corresponding to a plurality of transmission conditions.

6. The method according to claim 4, wherein the predetermined sequences are adapted to their corresponding transmission conditions.

7. The method according to claim 4, wherein the predetermined sequences are substantially mutually uncorrelated.

8. The method according to claim 4, wherein the number of predetermined sequences in the set is equal to or greater than the number of possible transmission conditions to be conveyed.

9. A signal for transmission over a channel subject to transmission conditions, the signal comprising:
a packet structure;
a signalling structure provided within the packet structure for conveying information relating to said transmission condition; and
the signal further being adapted in accordance with said transmission condition.

10. The signal according to claim 9, wherein said signalling structure comprises an extended signalling structure.

11. The signal according to claim 9, wherein said signalling structure is provided in the beacon period of a MAC superframe.

12. The signal according to claim 9, wherein said signalling structure is provided in the preamble of the PHY frame structure.

13. The signal according to claim 9, wherein the signalling structure is provided after the synchronisation field and before the channel estimation field.

14. The signal according to claim 9, wherein the signalling structure is collocated with the channel estimation field.

15. A method of receiving a signal over a channel subject to transmission conditions, said signal comprising a signalling structure relating to the transmission condition, method comprising the steps of:
receiving said signal;
autocorrelating said signal decoding said signalling structure; and
adapting the reception of further signals to the transmission condition conveyed in the signalling structure.

16. The method according to claim 15, further comprising performing coarse synchronisation before decoding the signalling structure relating to the transmission condition

17. The method according to claim 15, wherein the step of decoding said signalling structure comprises:
performing a predetermined number of correlations corresponding to the number of predetermined sequences;
windowing each correlation result in accordance with the synchronisation information;
squaring and integrating the value of each windowed result;
determining the sequence obtaining the highest value; and
identifying the transmission condition related to the determined sequence.

18. The method according to claim 17, wherein the step of windowing further comprises matching the centre of each window to the zero-lag point in the output waveform of the correlation.

19. The method according to claim 15, wherein the transmission condition comprises interference detection and avoidance.

20. A transmitter adapted to generate a signal for transmission over a channel subject to transmission conditions in accordance with any one of claims 1 to 8.

21. A receiver adapted to receive a signal over a channel subject to transmission conditions in accordance with any one of claims 15 to 19.
